(19) United States
(12) Patent Application Publication
(10) Pub. No.: US 2019/0305968 A1
(43) Pub. Date: Oct. 3, 2019

(54) HUMAN-SOLVED PUZZLES AS PROOF-OF-WORK FOR BLOCKCHAIN

(71) Applicant: CA, Inc., New York, NY (US)

(72) Inventors: Steven Cornelis VERSTEEG, Ivanhoe (AU); John Sinclair BIRD, Ringwood (AU); Nathan Allin HASTINGS, Glen Iris (AU); Xien YAO, Doncaster (AU); Deborah Anne VETHECAN, Bulleen (AU)

(73) Assignee: CA, Inc.

(21) Appl. No.: 15/937,392

(22) Filed: Mar. 27, 2018

(51) Int. Cl. H04L 9/32; G06F 21/36; H04L 29/06; H04L 9/06

(52) U.S. Cl. CPC H04L 9/3271; G06F 21/36; H04L 63/12; G06F 2221/2103; H04L 2209/38; G06F 2221/2133; H04L 9/0637

(57) ABSTRACT

A method includes identifying a set of computing-resistant puzzles and receiving human-input proposed solutions to at least a subset of the puzzles. The method further includes confirming the validity of the human-input proposed solutions and producing a proof-of-work based on at least a threshold quantity of validated human-input proposed solutions. A new block including the produced proof-of-work is added to a blockchain database.

### BACKGROUND

This present disclosure relates to blockchain technology, including the architecture of a blockchain database and proof-of-work system and function, and more specifically to blockchain architectures that implement human-solved puzzles as proof-of-work.

### BRIEF SUMMARY

According to an aspect of the present disclosure, a method includes identifying a set of computing-resistant puzzles and receiving human-input proposed solutions to at least a subset of the puzzles. The method further includes confirming the validity of the human-input proposed solutions and producing a proof-of-work based on at least a threshold quantity of validated human-input proposed solutions. In addition, a new block, which includes the produced proof-of-work, is added to a blockchain database.

Other features and advantages will be apparent to persons of ordinary skill in the art from the following detailed description and the accompanying drawings.

### BRIEF DESCRIPTION OF THE DRAWINGS

FIG. 1 illustrates a network of distributed nodes.

FIG. 2 illustrates a blockchain.

FIG. 3 illustrates a modified segment of blocks from the blockchain of FIG. 2.

FIG. 4 illustrates a discrepancy in the chain caused by conflicting hash values.

FIG. 5 illustrates a segment of the blockchain of FIG. 2 split with two chain tips.

FIG. 6 illustrates growth of the chain tip of FIG. 5.

FIG. 7 illustrates generation of a set of puzzles by trusted sources and puzzle data architecture and composition.

FIG. 8 illustrates distribution of the set of puzzles over the network.

FIG. 9 illustrates user-input solutions to puzzles to nodes on the network.

FIG. 10 illustrates distribution of the user-input solutions over the network.

FIG. 11 illustrates adding a block including the puzzles and corresponding user-input solutions to the blockchain.

FIG. 12 illustrates a composition of the new block.

FIG. 13 illustrates an algebraic embodiment of the present disclosure.

FIG. 14 illustrates an abstract blockchain with a longest chain and several orphaned blocks and chain tips.

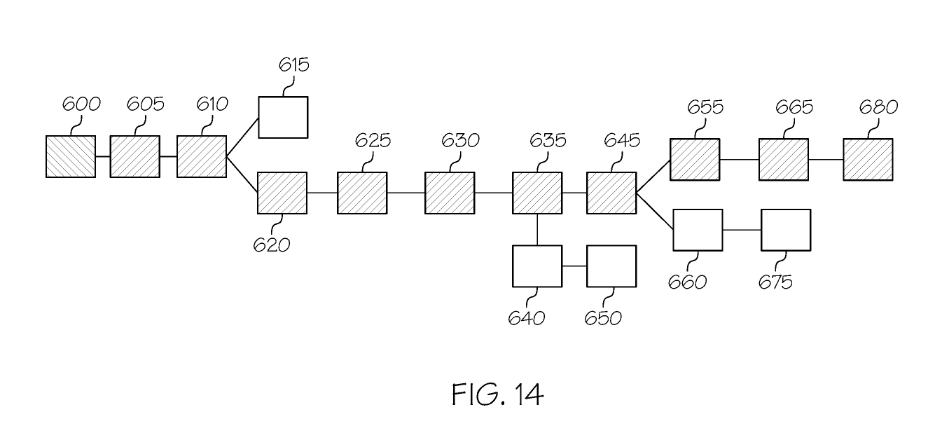

### DETAILED DESCRIPTION

One skilled in the art appreciates that aspects of the present disclosure may be illustrated and described as pertaining to several patentable classes or contexts, including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or in a combined software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

The aspects of the present disclosure may use one or more computer readable media. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would comprise the following: a portable computer diskette, a hard disk, a random access memory (“RAM”), a read-only memory (“ROM”), an erasable programmable read-only memory (“EPROM” or Flash memory), an appropriate optical fiber with a repeater, a portable compact disc read-only memory (“CD-ROM”), an optical storage device, a magnetic storage device, or any suitable combination of the foregoing. In the context of this document, a computer readable storage medium may be any tangible medium able to contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take a variety of forms comprising, but not limited to, electro-magnetic, optical, or a suitable combination thereof. A computer readable signal medium may be a computer readable medium that is not a computer readable storage medium and that is able to communicate, propagate, or transport a program for use by or in connection with an instruction execution system, apparatus, or device. Program code embodied on a computer readable signal medium may be transmitted using an appropriate medium, comprising but not limited to wireless, wireline, optical fiber cable, RF, etc., or any suitable combination of the foregoing.

Computer program code for carrying out operations for aspects of the present disclosure may be written in a combination of one or more programming languages, comprising an object oriented programming language such as JAVA®, SCALA®, SMALLTALK®, EIFFEL®, JADE®, EMERALD®, C++, C#, VB.NET, PYTHON® or the like, conventional procedural programming languages, such as the “C” programming language, VISUAL BASIC®, FORTRAN® 2003, Perl, COBOL 2002, PHP, ABAP®, dynamic programming languages such as PYTHON®, RUBY® and Groovy, or other programming languages. Unless specifically indicated otherwise, the program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider) or in a cloud computing environment or offered as a service such as a Software as a Service (“SaaS”).

This disclosure includes flowchart illustrations and/or block diagrams of methods, apparatuses (e.g., systems or computers), and computer program products according to embodiments of the disclosure to reference aspects of the present disclosure. Each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks, or otherwise described herein.

These computer program instructions may also be stored in a computer readable medium that, when executed, may direct a computer, other programmable data processing apparatus, or other devices to function in a particular manner, such that the instructions, when stored in the computer readable medium, produce an article of manufacture comprising instructions which, when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses, or other devices to produce a computer implemented process, such that the instructions which execute on the computer or other programmable apparatus provide processes for implementing the functions/acts specified in the flowchart and/or block diagram block or blocks.

While embodiments of the present disclosure may be described with respect to financial transactions or cryptographic currencies, or other industry, one of ordinary skill in the art appreciates that the embodiments disclosed herein are useful in other industry, context, and application. Specifically, the methods, computers, and systems described herein are not limited to application in the context of blockchain-based cryptographic currencies, and one of skill in the art will appreciate that many embodiments fall within the scope of the present disclosure.

Blockchain technology refers generally to a technique for storing information. In other words, a blockchain is a type of database. Rather than storing the database in a single central location, blockchain refers distributed databases, which may be maintained and managed by peer-to-peer networks comprised of many nodes, wherein the nodes maintain the blockchain according to an agreed protocol. Blockchain technology is not limited to peer-to-peer networks, and several applications to private networks are emerging.

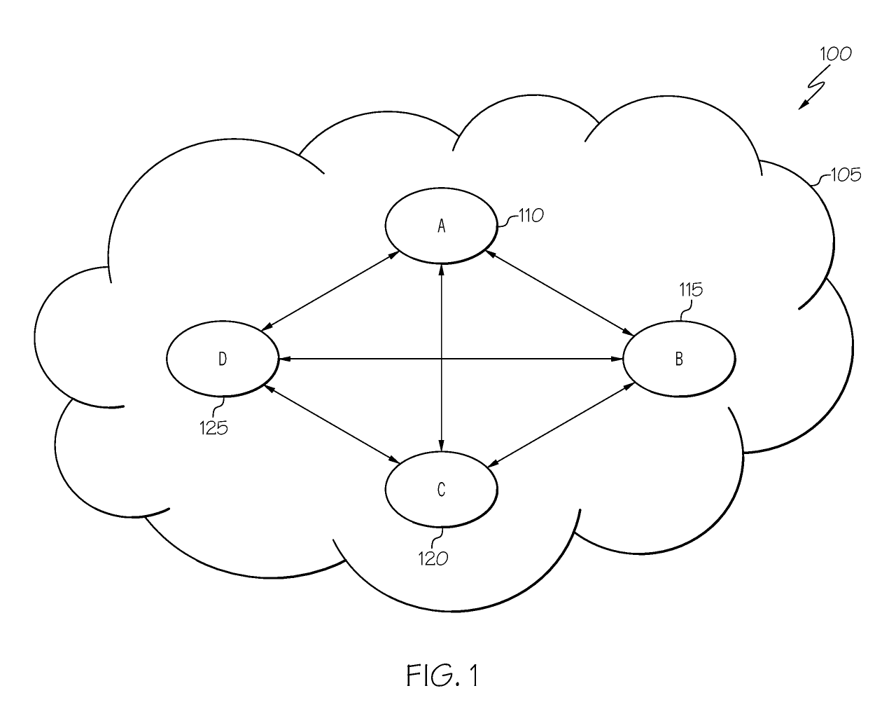

A network 105 of distributed nodes is illustrated in FIG. 1. FIG. 1 illustrates four nodes, node A 110, node B 115, node C 120, and node D 125; however, embodiments of the present disclosure may include fewer or more than four nodes. In addition, network 105 may be the Internet. Network 105 may be a Bluetooth™ network, a Wifi network, cellular network, local area network, wide area network, storage area network, virtual private network, personal area network, or other type of network. Thus, network 105 may be a wired or wireless network or, in certain embodiments, may be wired and wireless.

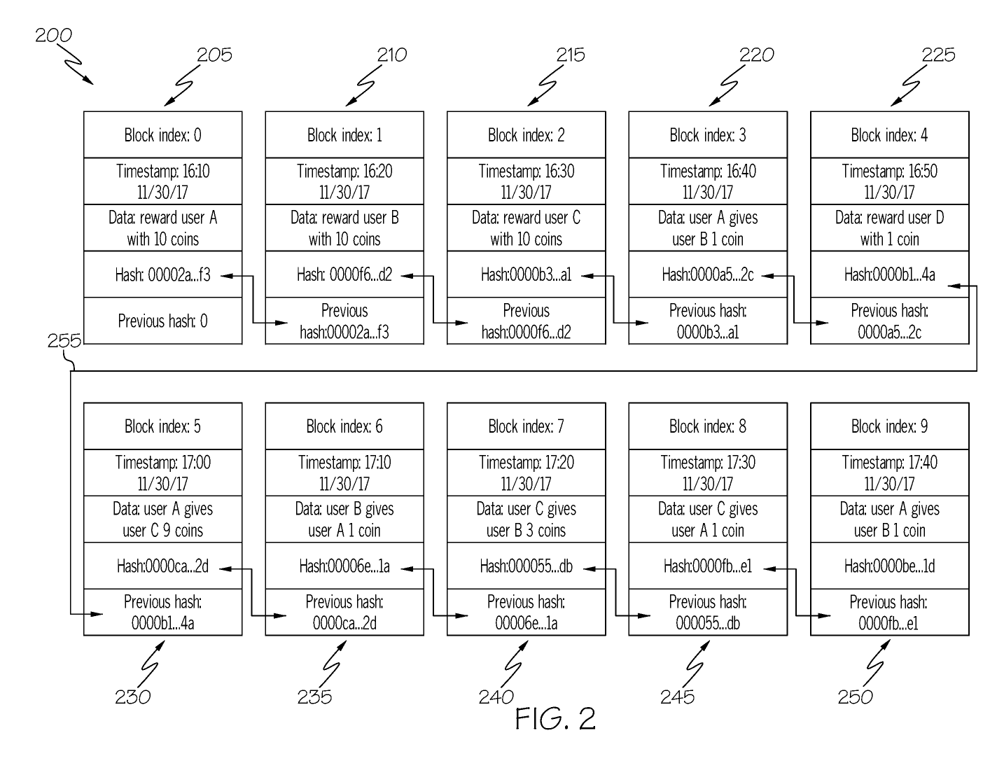

A blockchain database, such as that illustrated in FIG. 2, may include one or more blocks. For example, the segment of blockchain database 200 illustrated in FIG. 2 includes ten blocks (205, 210, 215, 220, 225, 230, 235, 240, 245, and 250). The blockchain refers generally to a data structure or database for storing the blocks. For example, the blocks may be stored using an array data structure, or more simply, an array. Arrays, as one of ordinary skill in the art would appreciate, refer generally to a collection of elements. One of skill in the art would recognize other techniques for storing and accessing a collection of data elements. For example, blockchains may be implemented using data structures other than the array, such as lists including linked lists, and other tree-based data structures. Block structures may be linked expressly or inherently. For example, blocks may be linked via pointers, including linkage by hash pointer to other blocks of the blockchain data structure, such as hash pointer link 255.

Blockchains may be used to store or record varying types of data. Blockchain technology can be used to store and record a ledger of transactions, contractual obligations, sensitive data, time-based data, file systems, decentralized cloud file storage, for example. Storing data in the blockchain itself is one solution, however, an alternative is to store representations of the data in the blockchain and use the blockchain to test the veracity and integrity of data stored elsewhere. In this way, the blockchain may store immutable fingerprints of data, rather than the actual data. The blockchain may include a genesis block, such as genesis block 205 illustrated in FIG. 2. The genesis block may be a hardcoded block that anchors the blockchain. The genesis block may or may not contain block data.

Blocks may be data structures. In some embodiments, a block comprises an n-tuple set of data values. As illustrated in FIG. 2, a block 250 may include, for example, an index value, a timestamp, block data, a hash value of the block itself, and a hash value of the previous block in the blockchain. As FIG. 2 illustrates, a chain of blocks, linked together through hash pointers, such as hash pointer 255, is created by including in each block the hash value of the block before it. Chaining, or use of the overlapping hashes, is a fundamental aspect of the system and functions that protect the integrity of the blockchain.

Blockchain pundits often describe blockchain databases as being immutable. Immutability refers to an unchanging or tamper-resistant property, which in the context of blockchains means that blockchain data is difficult to tamper with or modify once added to the blockchain. As illustrated in FIG. 2, blocks 210, 215, 220, 225, 230, 235, 240, 245, and 250 include data representing a record of a coin transfer, which could be a transaction involving a cryptographic currency, such as Bitcoin.

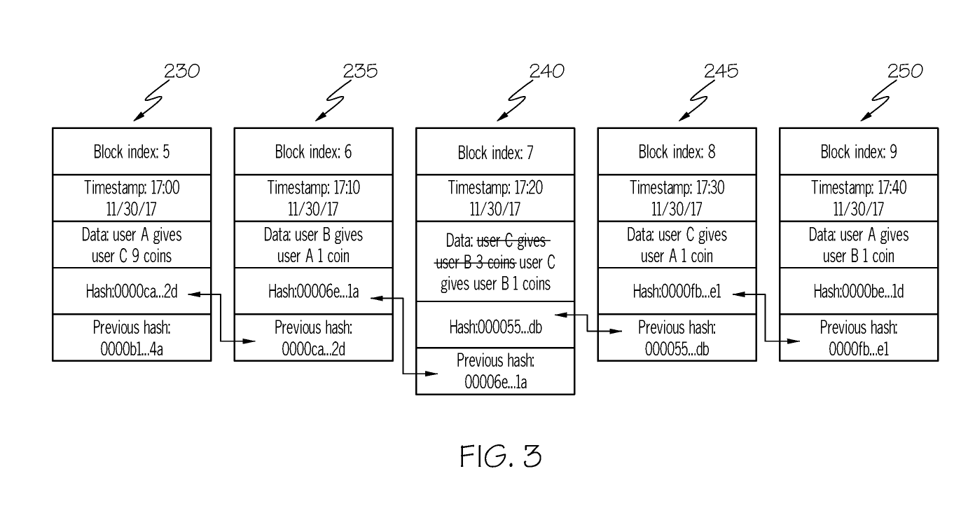

To illustrate the tamper-resistant properties of blockchain databases, consider the following example. The block data of block 240 records or memorializes a transaction in which user C transferred three coins to user B. Suppose however that user C wanted some of those coins back, and tried to modify block 240 so that only 1 coin, or no coins, were transferred to user B. Perhaps user C would like to “double spend” some of those coins. User C could modify block 240, as illustrated by the strikethrough in FIG. 3, and broadcast its chain including the fraudulent transaction to the blockchain network, thereby attempting to trick nodes into accepting the chain containing the fraudulent block 240.

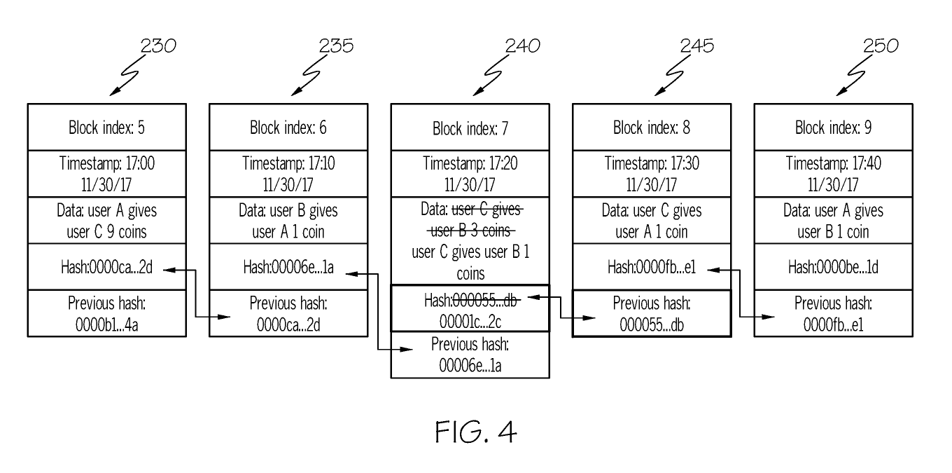

In a properly implemented blockchain however, User C's attempt should fail because the blockchain security mechanisms would detect block 240 had been tampered with. After modifying the contents of block 240, block 240's hash value would fail validation. By including the hash value of the block in each block, blocks can be verified and tampering easily detected by applying the cryptographic hashing algorithm to the block to obtain the block's hash value and comparing the determined hash value with the hash value recorded as part of the block. Cryptographic hash functions take an input and return a fixed size value or string. The output value form the hash function may be referred to as a hash value, message digest, digital fingerprint, digest, or checksum. Cryptographic hash functions preferably make it easy to calculate a hash value for any data input, make it computationally difficult to calculate the data input given the hash, and make it extremely unlikely that two nearly-identical but slightly different inputs have the same hash. Thus, if the transactions in the block are tampered with after creation and setting the hash value, the hash value of the tampered block will not be the same as the original block, and a discrepancy will exist between the block's hash value and its recorded hash value. This discrepancy may result in nodes rejecting the chain containing the fraudulent block 240. In an effort to fool the blockchain protocol, user C may recalculate and reset block 240's hash value to match the hash value of the tampered block, as illustrated with strikethrough in block 240 of FIG. 4. However, user C cannot simply recalculate and reset the hash of block 240 because doing so would break the chain. Recalculating the hash and updating the block's hash to match its contents may cause the block to pass validation individually, but chain validation would fail validation because block 245 now references a block hash that does not exist and does not accurately reflect the hash value of block 240 after it was tampered with, as illustrated in FIG. 4.

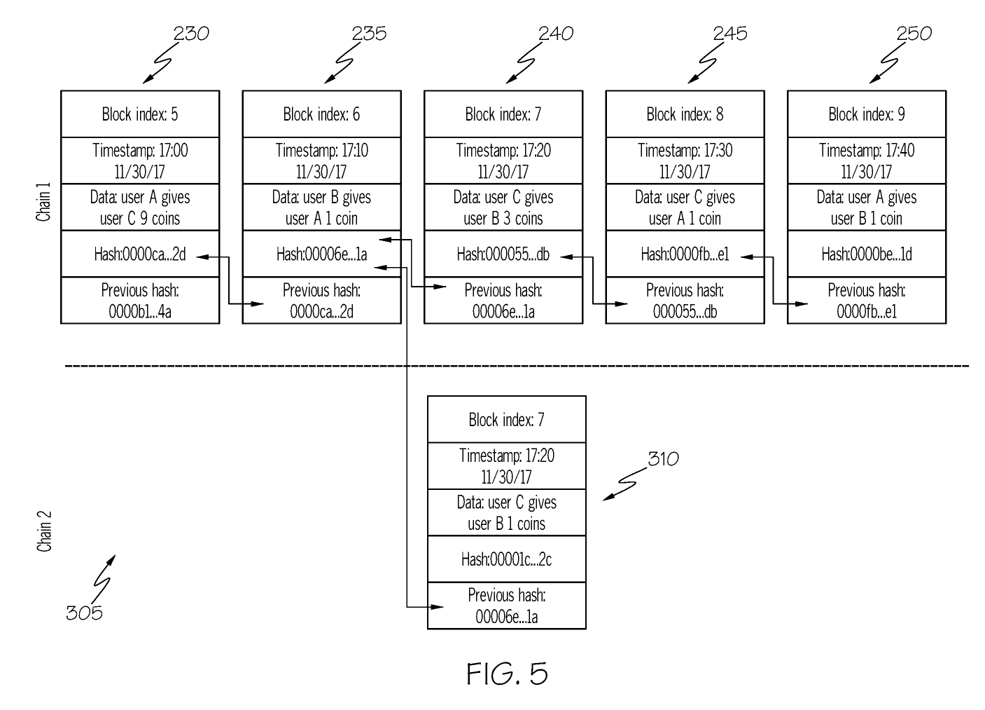

Thus, to effectively tamper with the blocks in a blockchain, each block following the tampered block must be rebuilt and rehashed, and the contents of the previous-block-hashes replaced with the new hash values to, in effect, build a new chain. More specifically, as FIG. 5 illustrates, user C may attempt to create a new chain by distributing chain 2 illustrated in FIG. 5 to the blockchain network. Chain 2 would likely be valid, in that each of its blocks is properly ordered and references the correct hash, but nodes must reconcile whether to adopt chain 1 or chain 2, and they may use a protocol known as the longest-chain-rule to do so. In this example, chain 1 has a length of nine blocks, whereas chain 2 has a length of 7 blocks. The longest-chain-rule implemented in some blockchain architectures holds that when nodes are confronted with a choice between two chains, they choose the longer chain. Thus, while user C can broadcast a chain 305 with a fraudulent block 310 in an attempt to take back two of the coins user C transferred to user B in block 240, a node receiving chain 305 may, in addition to verifying each block, determine whether chain 305 is the longest chain it has seen or received. In this example, chain 305 and fraudulent block 310 would be orphaned, and no other users would attempt to build on that branch of the chain, i.e., on top of block 310, because it is not part of the longest chain.

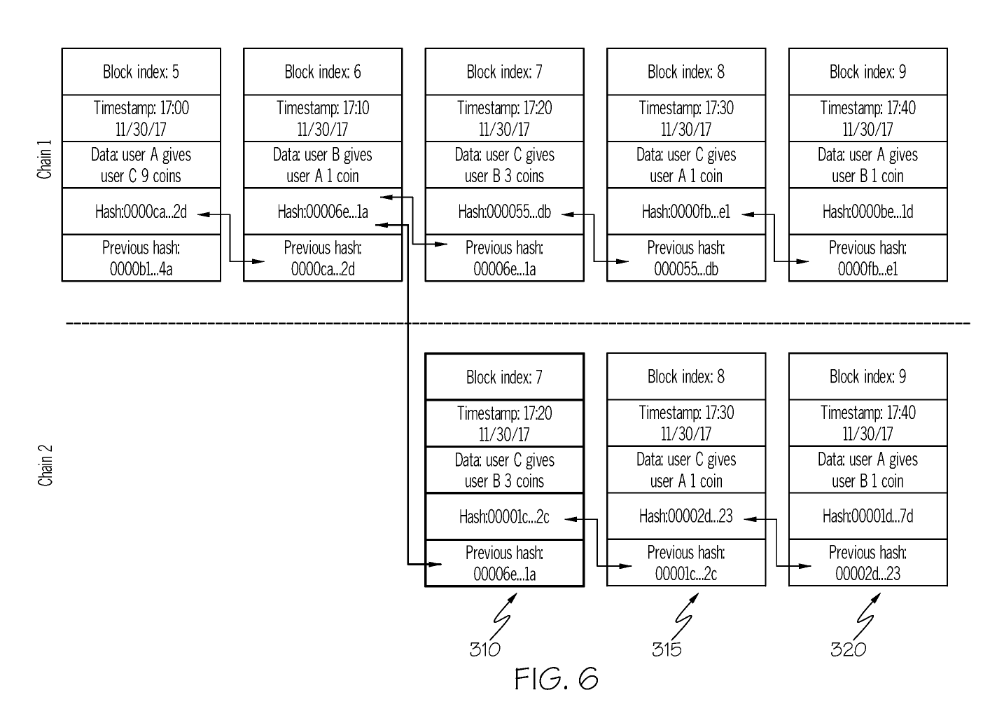

It follows then, that in order to effectively tamper with the blockchain, the malicious user, in the present example user C, must rebuild the blockchain on top of the tampered block to a length where the chain including the tampered block is the longest chain. In other words, referring now to FIG. 6, if user C creates a fraudulent block 310 that takes back two of the coins transferred to user B in block 240, and subsequently builds blocks 315, 320, and 325 on top of block 310, nodes on the blockchain network would accept chain 2 because it is longer than chain 1. Causing the majority of the nodes to accept fraudulent chain 2 by manipulating the longest chain rule would would cause the fraudulent transaction to be accepted by the majority of the nodes on the network. These nodes would discard chain 1 as not being the longest chain and would then mine chain 2. Thus, in order to have his or her fraudulent efforts be successful, user C must rehash and rebuild all of the subsequent blocks in the chain, and overtake the blockchain by at least a block, thereby leveraging the longest-chain-rule in the network protocol to cause nodes to adopt the fraudulent chain. If user C is successful in creating a longer chain with seemingly valid (not necessarily authentic) blocks, the protocol and architecture of the blockchain may cause nodes to adopt the fraudulent, but longer, chain as the best chain. It is thus easy to see how a user with enough computational power and energy resources could overtake the blockchain network by building blocks and growing a chain faster than the honest participants on the network could and thereby supplant an authentic chain with a fraudulent one.

One of skill in the art would appreciate that computing hash values to rehash and rebuild the blocks, while computationally intensive in and of itself, is not computationally difficult or resource intensive enough to prevent attacks given today's computing machines. Thus, a proof-of-work system is central to many blockchain architectures. Proof-of-work systems make it difficult to create valid blocks and thus more difficult to recreate and rebuild blocks by requiring significant amounts of work be spent and expended to create a block. Proof-of-work may refer to a system or function, i.e., a protocol, for producing a proof-of-work. A proof-of-work may describe the piece of data that is difficult, costly, and/or time consuming to produce or discover, but easy for others to verify. Proof-of-work protects the integrity of the blockchain database by requiring, for example, expenditure and investment of computational power and energy to achieve consensus across the distributed blockchain database. Proof-of-work systems are economic deterrents to denial-of-service (DoS) or distributed-denial-of-service attacks (DDoS) by requiring work and expenditure of some limited resource. The theory is that requiring a certain amount of resources to access a resource, for example to modify the blockchain by creating or rebuilding blocks, deters against fraudsters from overloading and effectively hijacking the blockchain by creating fraudulent blocks faster than honest users create authentic blocks.

Typically, the proof-of-work puzzles are asymmetric in that they are difficult to find a solution or solve, but easy to verify the solution once it has been found. Bitcoin, a cryptocurrency based on blockchain technology, uses a proof-of-work technique that consumes computational power and energy to solve cryptographic puzzles at varying degrees of difficulty. The general premise behind proof-of-work is making it so difficult to generate a valid block that it makes it computationally impracticable to gather enough computational resources to outrun or out-mine the honest users of the blockchain. In the Bitcoin system, the proof-of-work function imposing a target hash problem or puzzle makes it computationally difficult to build a valid block. To summarize this proof-of-work system or protocol, Bitcoin requires miner nodes to solve cryptographic hashing puzzles that require finding a nonce or “salt” value that, when hashed with the remainder of the block, results in a hash value of a certain size (i.e., a specified number of leading zeros). The smaller the target hash value, i.e., the more leading zeros, the more difficult the cryptographic hashing puzzle. The computational work required to solve the puzzle is processing power to compute and test hashes using different nonce values until the node, or a different node, finds a solution and adds a valid block to the blockchain. Therefore, the proof-of-work required in the Bitcoin system requires not only calculating a block's hash value, but making sure the calculated hash is below a certain number. The node must repeatedly adjust the nonce value and rehash the block until the node calculates a hash value that is less than the target number. It may take thousands of iterations to find a salt value giving a valid target hash for a given block.

Continuing with the example above with user C overtaking the blockchain by creating blocks faster than the honest miners on the network, consider if the example blockchain used the Bitcoin proof-of-work function. Therefore, not only would user C need to recalculate the block's hash and create a longer chain, user C needs to expend a large amount of computational power and consume a large amount of energy to generate a valid hash that meets the target hash criteria for each block that must be rebuilt. Thus, the further back in the chain the tampered or fraudulent block, the more computational power and energy is required, and the less likely it is the block could be effectively tampered with. Thus, using proof-of-work functions in the blockchain architecture requires the proof-of-work for the entire chain be redone in order to tamper with the chain and rewrite the history of transactions.

The computational power and energy consumption required to solve complex cryptographic hashing puzzles as proof-of-work is expensive. It may also be wasteful, in that all the energy consumed by miners who do not find a solution to the puzzle is put to no use. In addition, in the Bitcoin system, only the miner who found the solution receives the Bitcoin reward, which is intended to compensate the miner for the computational power and energy consumed in solving the puzzle. Moreover, Bitcoin's proof-of-work protocol inevitably will require more energy as the network grows and processing power increases. In the Bitcoin blockchain architecture, the difficulty of the cryptographic hashing puzzles fluctuates, and adjusts depending on how fast blocks are being created. The Bitcoin proof-of-work system is designed such that the difficulty of the hashing puzzles should be adjusted so that salt values are found and valid blocks are added to the blockchain at a rate of one block roughly every ten minutes. If a malicious user or group of users collude to pull together enough resources to generate blocks faster than on block every ten minutes, thereby gaining on the honest miners and making it inevitable to outrun the honest users in finding new blocks, bitcoin will automatically adjust by making the puzzles harder to keep the rate of producing a new block at the target time of ten minutes. Increasingly, as computational power is added to the Bitcoin system, the Bitcoin blockchain architecture consumes more energy. Thus, the Bitcoin blockchain architecture not only is built upon and leverages immense power consumption, it requires it as proof-of-work to economically deter corruption or fraudulent manipulation of the blockchain. Accordingly, blockchain architectures which do not consume vast amounts of real energy are important to sustaining the blockchain technology.

The present disclosure provides a method and system that improves blockchain database technology by reducing the energy consumed by the blockchain architecture and validation mechanisms without reducing the complexity and security of the blockchain proof-of-work. The methods and systems described herein disclose a blockchain architecture that uses human effort, rather than computational power and energy consumption, to solve puzzles as the proof-of-work system or function for the blockchain architecture. The methods and systems within the scope of the present disclosure improve blockchain architecture by describing a proof-of-work that is more efficient, less wasteful, and consumes less energy.

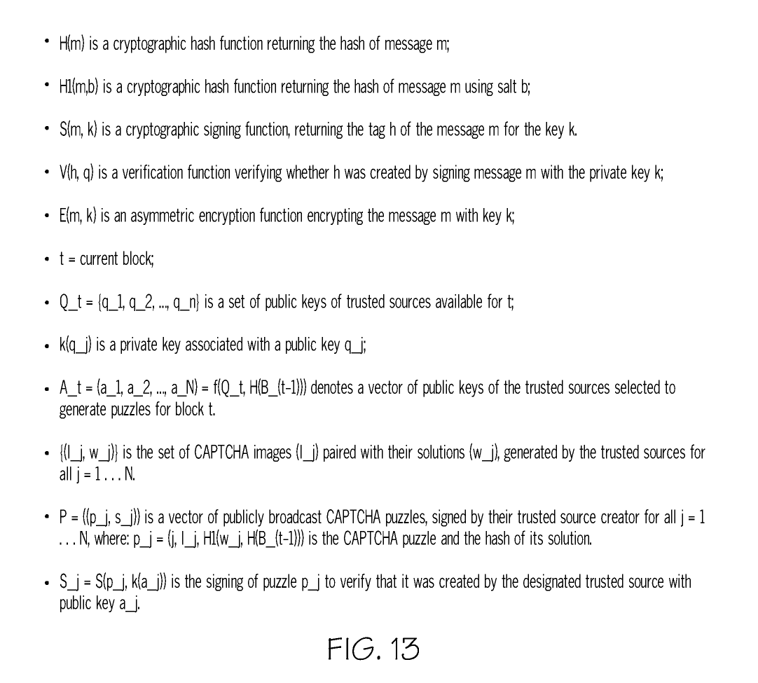

The disclosure that follows references algebraic expressions from time to time as representations of an exemplary implementation of the blockchain architecture within the scope of the present disclosure. For reference, FIG. 13 provides a summary of the algebraic definitions referenced herein.

The embodiments described herein may involve a network of participants to a blockchain. The participants may be referred to as nodes, and nodes may serve different purposes or specialized purposes on the blockchain network. Some nodes find blocks, write blocks, solve puzzles, and serve the proof-of-work function in the blockchain architecture. Other nodes maintain the blockchain by validating and propagating new entries and/or blocks, and storing full copies of the blockchain database. Yet other nodes are users participating in the blockchain network through some end-user functionality and may provide data to store or record in the blockchain. Some nodes may perform one or more than one of these functions. The nodes connected to the network may also monitor the network for transmissions of interest as part of performing their relative functions.

In some embodiments, nodes are computing devices. For example, nodes may be personal computers, cell phones, smart phones, tablets, servers, and the like. To participate in the blockchain peer-to-peer network, the nodes may have networking capabilities and hardware. Some nodes include various interface devices such as human-interface devices through which human-input is obtained and processed. Human input devices include input/output devices such as a mouse, keyboard, microphone, camera, stylus, touchscreen, and other similar input/output devices.

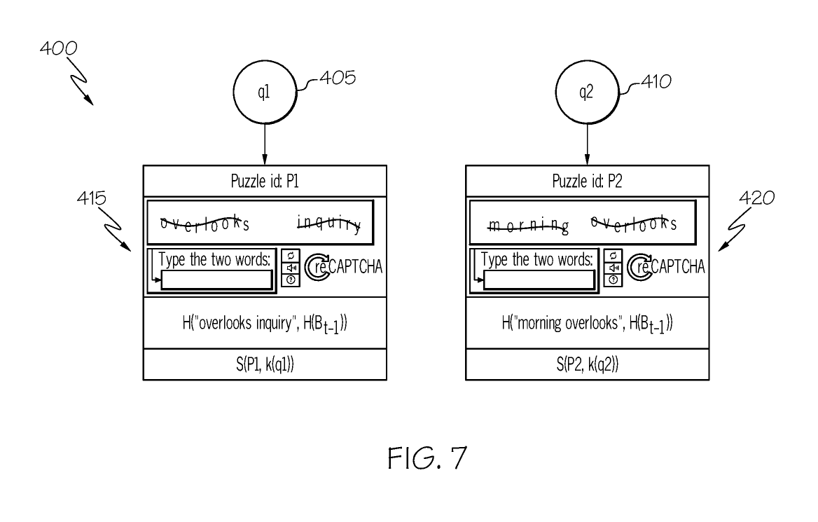

The proof-of-work function and corresponding blockchain architecture described herein may leverage human effort as proof-of-work required for each block on the blockchain. For each block, including the current block (t), trusted sources, such as trusted source 405 and trusted source 410 illustrated in FIG. 7, may generate a plurality or set of puzzles. The puzzles and their validated solutions may serve as the proof-of-work in the present blockchain architecture.

A set of puzzles may be generated and created by a trusted source, such as trusted source 405 and trusted source 410. In certain embodiments, the puzzle set may include several puzzles, and each puzzle within the puzzle set may include multiple sub-puzzles or tests. Embodiments of the blockchain architecture described herein may use alternative means of trusted sources for puzzle generation. For example, the source of the puzzles may be a single source or multiple sources. In embodiments with multiple sources of puzzles, the system may designate which labels of puzzles (i.e., from 1 to N) should be created by which source. In this way, a pseudo-random number generator may be used for allocating puzzle providers, and in certain embodiments, the generator may be seeded with the hash of the previous block. Another feature of the blockchain architecture may determine a trusted puzzle source as one which is trusted by a majority of the network. In such an embodiment, if the majority of the network does not trust the source, then puzzles generated, distributed, or signed by that source will not be considered or solved by the nodes, according to the protocol administering the blockchain. To facilitate communication of trusted and untrusted sources of puzzles within the network, lists of trusted and untrusted sources may be maintained and shared amongst nodes or written to a registry, or to the blockchain itself In some embodiments, a set of public keys Q_t={q_1, q_2, . . . , q_n} may be a set of public keys of the trusted sources available for the current block t. Nodes on the network may receive a distribution of the trusted public keys or may access the public keys via the blockchain network. In such embodiments, nodes are able to verify a trusted source generated a puzzle by verifying it with its public key, q_j. Thus, in some embodiments, trusted sources may sign puzzles with a private key, denoted k(q_j), which users or nodes may then decrypt using the public key, q_j, corresponding to the respective trusted source.

In some embodiments, trusted sources may be selected to generate puzzles for block t, and the vector A_t=(a_1, a_2, . . . , a_N)=f(Q_t, H(B_(t−1))) denotes a vector of public keys of the trusted sources selected to generate puzzles for block t. In such embodiments, the vector A t may be deterministically selected from the set of available sources and the selection function f( ) is also a function of the hash of the previous block, t−1.

An alternative or supplementary technique for trusted puzzle generation is a decentralized trust model. In the decentralized trust model, any network node may generate a puzzle. In such embodiments, the protocol may randomly select nodes to generate puzzles based on the hash of the previous block. For example, nodes may be selected by the starting digits of their representative public key, or selected from the public key of active wallets in the previous block, or selected from active wallets with a balance above a determined threshold. That is, nodes with a certain stake in the blockchain may be selected to generate puzzles. In these exemplary embodiments, selected nodes may not solve their own puzzle or may be prohibited from broadcasting any solutions to any puzzles for the current block. In certain embodiments, the system may allow multiple trusted sources to generate the same puzzle number as a protection against a malicious attack by one of the trusted sources.

For exemplary purposes, the blockchain and proof-of-work architecture described herein may be described with reference to CAPTCHA puzzles. CAPTCHA is an acronym for “Completely Automated Public Turing test to tell Computers and Humans Apart.” CAPTCHA puzzles may be a type of challenge-response test with characteristics making it difficult for a computer to solve without human input, and are widely used to determine whether or not a user seeking to access a resource is a human. In such embodiments, solving a CAPTCHA puzzle is a computationally very difficult; however, it is relatively easy for a human to solve. Thus, tampering with the blockchain and redoing the human work requires either an immense amount of computational power to solve the CAPTCHAs, or a large army of human workers to solve the CAPTCHA puzzles. With CAPTCHAs as proof-of-work, the human effort is asymmetric in that human effort is required to solve the puzzle, but no human effort and very little computer effort is required to verify the solution. While exemplary architectures described herein are provided with respect to CAPTCHA puzzles, other types of puzzles requiring human work are contemplated. Specifically, the methods and systems described herein may be implemented using various categories of CAPTCHA puzzles including CAPTCHAs based on text, image, audio, video, puzzle assembly, or other types puzzles including, for example, crossword puzzles, image recognition puzzles, and other similar puzzles involving human work that are more readily solved by human power than computer power.

For each block, a set of N puzzles may be generated in the current round. For example, while the blockchain is still in its infancy and the number of participants is relatively low, the set of puzzles may comprise a hundred puzzles. For another given round, the set of puzzles may comprise fifty puzzles, or one thousand puzzles. In some embodiments, the number of puzzles in each set for a given round may be a function of the number of participants in the blockchain system. For example, some embodiments may increase the number of puzzles in the set for a given round as the number of participants in the network increases. In such embodiments, more puzzles for each round may be required to compensate for growing numbers of participants in the system. In other embodiments, the number of puzzles in each set for a given round may be a function of the number of blocks in the blockchain. For example, some embodiments may increase the number of puzzles for each round as the number of blocks on the chain increase, thereby requiring more work as the blockchain grows.

Referring now to FIG. 7, in certain embodiments, each CAPTCHA puzzle may be labeled from 1 to N, as seen with CAPTCHA puzzle 415 and CAPTCHA puzzle 420, to denote which of the N puzzles it corresponds to for that round out of a determined number of puzzles for the respective round. For example, FIG. 7 illustrates two puzzles, 415 and 420. The puzzles may be signed with the signature of the CAPTCHA's creator, and/or the previous block, such that nodes can verify the puzzle was generated by a trusted source. For example, FIG. 7 illustrates that puzzle 415 is signed by the key k of trusted source 405. That is, S_j=S(p_j, k(a_j)) provides an algebraic representation of the signing of the puzzle p_j, which enables verification that the puzzle was created by the designated trusted source with public key a_j. In some embodiments, each puzzle may be paired and/or signed with its solution, as illustrated in FIG. 7 of including a CAPTCHA image and the solution in the puzzle. Expressed algebraically, {(I_j, w_j)} is the set of CAPTCHA images (I_j) paired with their solutions (w_j), generated by the trusted sources for all j=1 . . . N. Note that in some embodiments the solutions, w_j, are kept secret.

To protect the solution's secrecy, trusted puzzle generators may provide a puzzle comprising the puzzle image and the hash of its solution. In such embodiments, as illustrated in FIG. 7, the hash of the solution may be salted so that the solutions cannot be looked up in a reverse hash table, and in some embodiments, the hash of the previous block (H(Bₜ₋₁)) may be used as the salt to evidence the freshness of the puzzle. Such an embodiment allows the puzzle and proof-of-work to be easily and automatically verified once a solution has been found. Specifically, upon obtaining a user-input solution, the hash of the input solution can easily be compared and verified with the hash of the solution distributed with the puzzles.

CAPTCHA puzzles vary in complexity and thus can be used to vary the amount of “work” required. In general, puzzles should be of sufficient complexity such that it is not vulnerable to brute force attack by a machine guessing different combinations or solutions. There are many techniques for varying the amount of work, and thus the complexity of the puzzles, in the embodiments described herein. For example, each puzzle may contain multiple CAPTCHAs or a sequence of CAPTCHAs, thus imposing multiple tests per puzzle, rather than a single test per puzzle. In such an embodiment, the hash of the solution to the puzzle may comprise a hash of the sequence of solutions. In this embodiment, the solution can only be verified if the entire sequence of CAPTCHAs is correctly solved. An exponential increase in complexity is thereby achieved by increasing the number of tests per puzzle.

CAPTCHA puzzles often have variations of valid solutions. For example, CAPTCHA puzzles may accept both uppercase and lowercase solutions to the distorted text in the CAPTCHA image. In such embodiments, a normalized form of the solution may be included with the puzzle. Using known techniques of normalization, any valid solution can then be converted to normalized form and verified for its correctness.

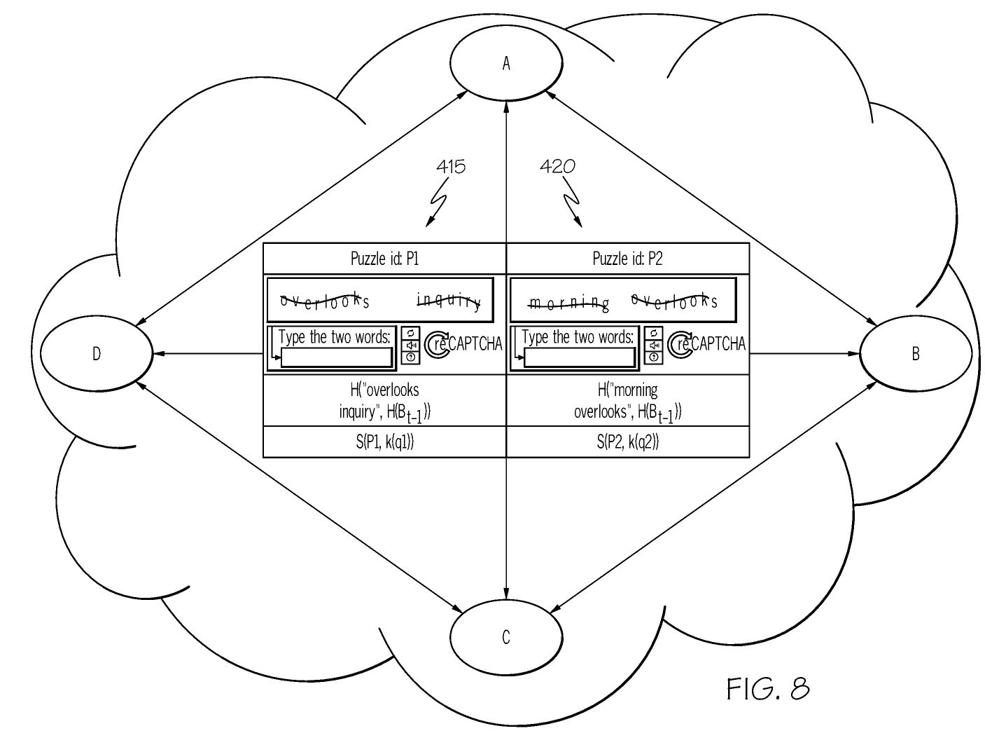

In certain embodiments, the set of CAPTCHA puzzles for each round may be transmitted over the blockchain network to participants of the network, as illustrated in FIG. 8. The transmittal of the set of puzzles may comprise, for example, a publicly broadcast vector of puzzles and may be signed by the trusted source that created the puzzles. In such embodiments, the vector may be comprised of a set of puzzles signed by their creator, wherein each of the puzzles broadcast in the vector may include the puzzle and a hash of the respective solution, as described herein. An algebraic representation of the broadcast set of puzzles may be given as P=((p_j, s_j)), where P is the vector of publicly broadcast puzzles, signed by their trusted source creator for all j=1 . . . N. Furthermore, p_j=(j, I_j, H1(w_j, H(B_(t−1))) provides an algebraic representation of the puzzle, p_j, and the hash of its solution, H1(w_j), where the hash is salted, in this embodiment, with the hash of the previous block, H(B_(t−1)), to evidence the puzzle's freshness and prevent the solutions from being looked up in a reverse hash table. In these embodiments, the CAPTCHA puzzles created may be broadcast across the blockchain network. Participant nodes in the network, for example mining nodes, may identify or receive the set of puzzles or a subset of the puzzles created and broadcast by the trusted source or sources for the current round.

With the puzzles distributed across the blockchain network, humans may view the list or vector of CAPTCHA puzzles available to be solved in the current round. In such embodiments, a human may solve a single puzzle or several puzzles. In some embodiments, the network node may choose a puzzle to be solved from the broadcast of puzzles for the current round and present the puzzle to a user.

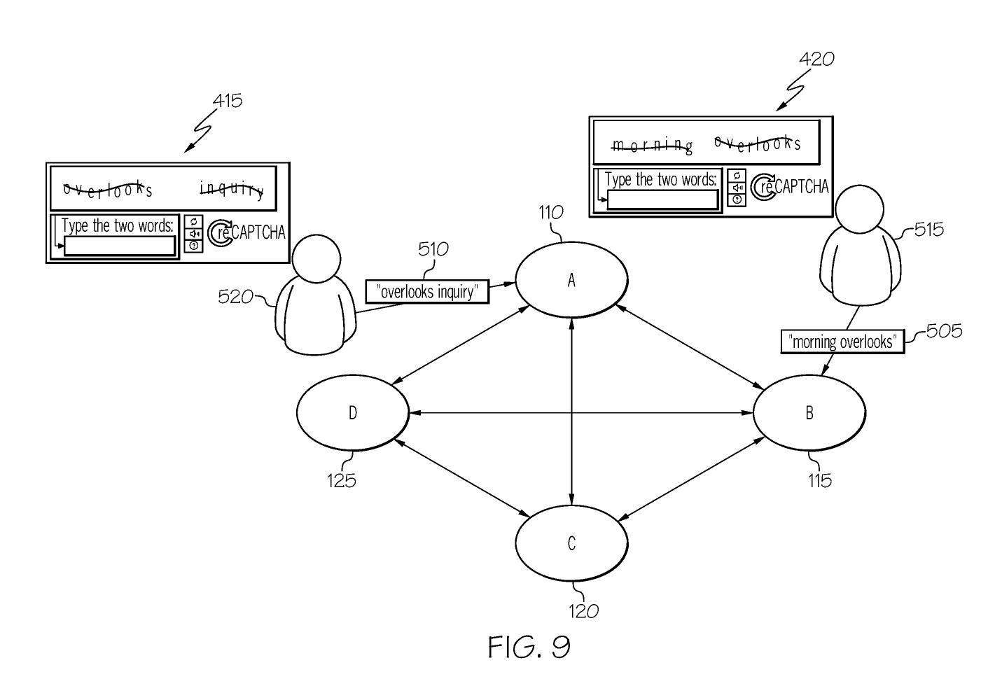

In either embodiment, the systems and methods disclosed herein may receive or identify user-input solutions to the CAPTCHA puzzles, as illustrated in FIG. 9. As FIG. 9 illustrates, human users solve the puzzles, for example CAPTCHA puzzles 415 and 420, and the human-input solutions are provided to the network node with which the user is interfacing. Furthermore, the human-input solutions to the puzzles of the puzzle set may be transmitted over the peer-to-peer network by several different nodes, and respectively, several different users. Nodes receiving user-input solutions to a puzzle, for examples node 110 and node 115 in FIG. 9, may verify or check whether the solution is correct. To verify or check the user-input solution, the node may be able to validate the answer by applying a cryptographic hashing algorithm to the user-input solution to obtain the corresponding hash value and comparing the hash of the user-input solution with the hash of the solution that may have been distributed with the puzzles in the vector or list of puzzles for the current round.

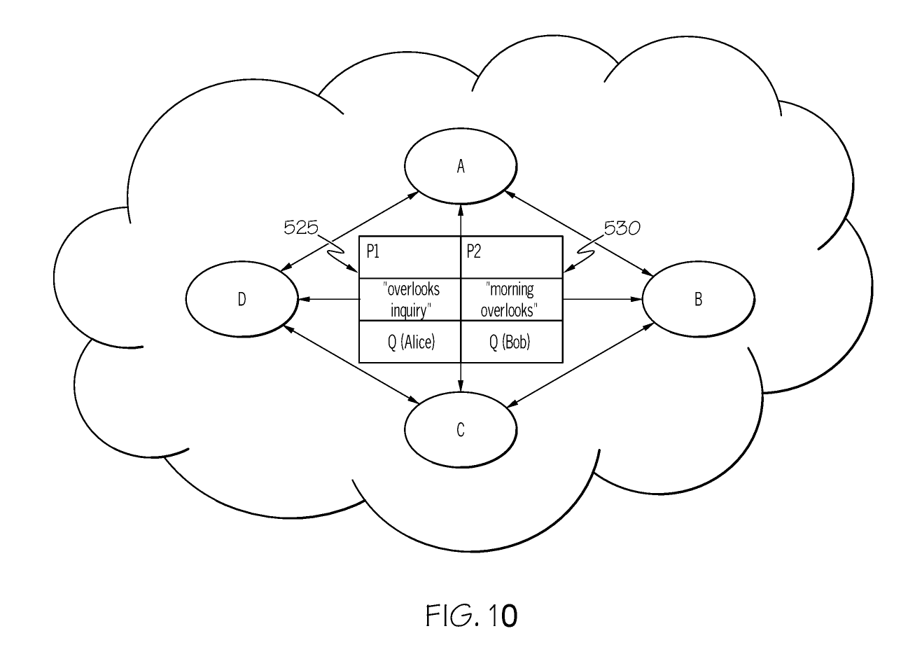

Referring now to FIG. 10, if a user-input solution is verified, the node may broadcast or publish the solution on the network, as illustrated by published solutions 525 and 530. The solution may be coupled with the solver's public key, so that the solving user can be rewarded for solving the puzzle. As solutions to the puzzles of the current round are found, nodes continuously broadcast all solutions that they have seen. If multiple solutions to the same puzzle are circulated over the network, the most broadcast solution may win. Nodes can verify the broadcast solutions by hashing the broadcast solution and comparing it to the hash of the solution that was transmitted with the puzzle broadcast.

In some embodiments, the solver of the puzzle may prove that a solution to the puzzle has been found without revealing the solution itself. Various techniques for keeping the solution secret can be utilized in the architecture herein disclosed, including, for example, using homomorphic encryption or homomorphic hashing techniques. The following discussion provides an example of how a solver can prove that they have solved a CAPTCHA without revealing the solution. First, a trusted source generates a private key, denoted ‘x’ in this example. The private key may be chosen using a deterministic method from the salted hash of the CAPTCHA solution, and the hash value of the previous block may be used as the salt. The public key corresponding to the private key may be included with the broadcast CAPTCHA puzzle, and the solution to the puzzle may be signed with the private key ‘x’. In certain embodiments, the public key corresponding to the private key may replace the hash of the puzzle solution in the broadcasted set of puzzles. In such embodiments, solving one of the CAPTCHAs reveals the private key ‘x’ to the solver because the solver is able to determine ‘x’ once in possession of the signed solution distributed with the puzzle and the user-input solution to the puzzle. Rather than publishing the puzzle solution in this embodiment, the solver may encrypt some agreed text, such as a predetermined string or the hash value of the previous block or some other solution indicator, with the private key ‘x’ and broadcast the signed text along with the puzzle identifier to prove to the other nodes that a solution to the identified puzzle has been found. Other nodes, without knowing the value of key ‘x’, are able to verify that the solver has in fact solved the puzzle by decrypting the message with the public key distributed with the puzzle corresponding to the private key ‘x’.

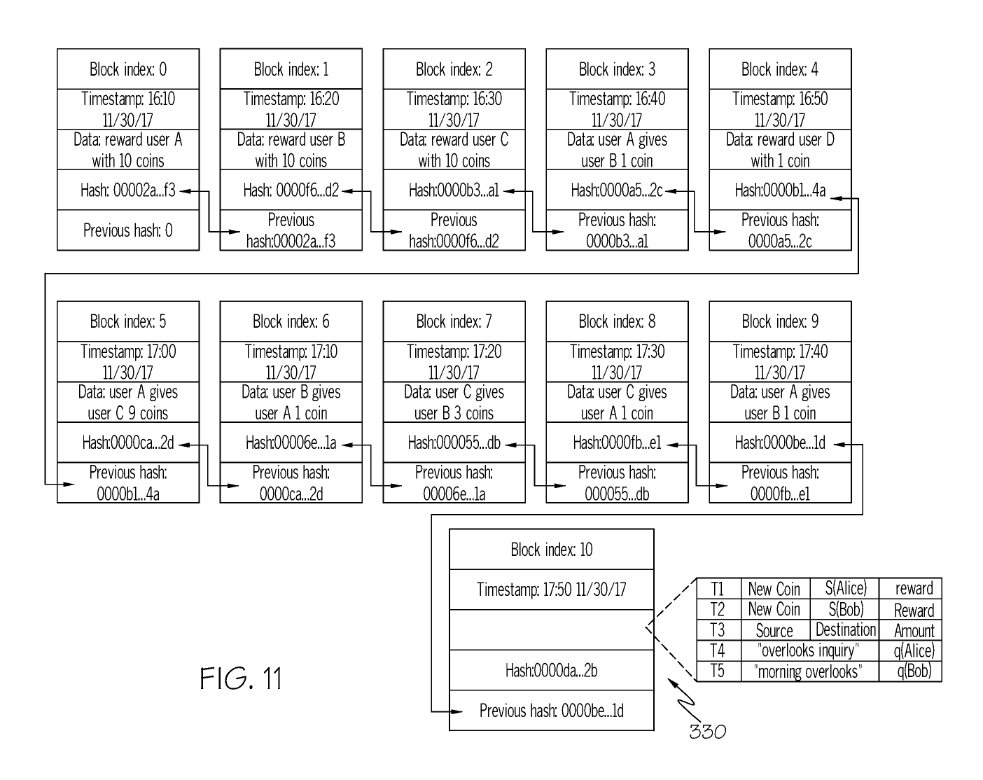

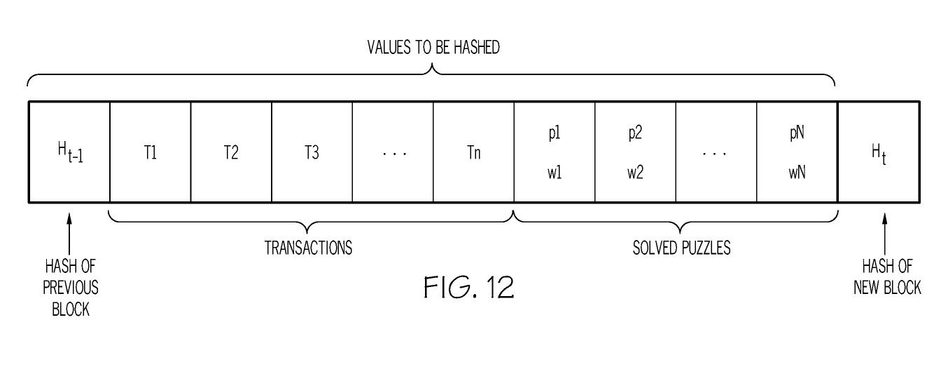

Nodes and blockchain networks which implement blockchain architectures within the scope of the present disclosure may monitor or track the solutions that have been found and broadcast such that the node is able to detect when it has seen a solution to all N puzzles of the current round. In some embodiments, when all N puzzle solutions for the round have been broadcast, nodes may begin publishing a completed block with all solutions and a new block 330 may be written to the blockchain, as illustrated in FIG. 11 and FIG. 12. In other embodiments, the system may require only a threshold of the N puzzles for the current round to be solved. When the threshold number of solutions have been published to the network, the current block can be sealed and created. In some embodiments, the threshold of puzzles of a given set of puzzles that is sufficient to produce a proof-of-work for the current block may be all of the puzzles in the given set or some subset of the puzzles of the given set.

Each block in the blockchain architecture and corresponding proof-of-work function described herein may include a token or representation of the work done to create the block, i.e., the proof-of-work of users' human power exerted to find solutions to the puzzles as realized by the user-input solutions. As described below, there are various ways produce a proof of work within the scope of the present disclosure, and one of skill in the art reviewing the present disclosure may envision others which are still within the scope of the architecture described herein. In each of the instances or embodiments of the proof-of-work described herein, the proof-of-work based on the puzzles and the solutions to the puzzles as those solutions are found and broadcast over the blockchain network. As has been explained, the human-input solutions may come from different users and different nodes connected to the peer-to-peer network. Thus, the proof-of-work function within the scope of the present disclosure may be based on a distributed proof-of-work implementation. The proof-of-work within the scope of the present disclosure then is unique in that it is associated with and represents work done by different nodes of the blockchain peer-to-peer network, as compared to the Bitcoin proof-of-work system where only one node produces the proof of work.

FIG. 12 illustrates an exemplary block architecture for the blockchain architecture within the scope of the present disclosure. As illustrated in the FIG. 12 embodiment, to represent the proof-of-work and incorporate it into the block, blocks may include each of the solved puzzles of the set of N puzzles in the block. In some embodiments, the block may include puzzle-solution pairs for each of the N puzzles for the current round. Thus, in such an embodiment, the puzzle-solution pairs that may be included in the block represent the proof-of-work for the block in the blockchain architecture described herein. In some embodiments, a hash of a puzzle and its solution may be included in the block. In some embodiments, the hash of the puzzles and solution may be a hash of all of the puzzles and corresponding solutions for that round together, in other words, as hash of all puzzles and corresponding solutions for each of the N puzzles of the current round. In yet another embodiment, the block may comprise separate hashes of each puzzle and solution pair, or some combination of these embodiments. In yet other embodiments, blocks may include each of the puzzles for the current round and a hash of the solutions separate, in groups, or all together. In other embodiments, the representation of the puzzle may be a puzzle identifier and the representation of the solution may be the hash value of the solution corresponding to that puzzle. Certain embodiments may include components and aspects of each of the various embodiments previously discussed.

These embodiments may represent the distributed consensus upon which blockchain technology requires by each of the nodes validating and expressing agreement that the solutions to each puzzle of the current round are in fact correct or valid solutions to the respective puzzles. Once such consensus has been obtained, i.e., by broadcasting and validating solutions to each of the puzzles of the current round or some threshold number of puzzles of the current round, that consensus may be memorialized in the current block, for example, by including a representation of the puzzles and solutions in the block. This way, a dishonest node seeking to rewrite history of transactions or data on the chain would need to re-solve each of the puzzles of a given round for a given block.

Like the Bitcoin blockchain and proof-of-work function, rewriting the history of the blockchain of the architecture described herein would require redoing the work of each block, which in this example, would require a team of humans to solve N puzzles. Thus, the architecture described herein provides sufficient tamper-resistance, i.e., immutability, by requiring proof-of-work without the increasing or inefficient expenditure and consumption of energy as required by the Bitcoin proof-of-work system.

To incentivize miners, i.e., the solvers of the puzzles, newly minted coins may be distributed to the accounts of all people who solved a puzzle. As illustrated in FIG. 11, block 330 indicates that both user A (Alice) and user B (Bob) were rewarded with new coin for solving puzzles P1 and P2 respectively. Thus, the proof-of-work blockchain architecture described herein may include a system of micro-rewards by rewarding different users or different nodes with a portion of the reward for solving the puzzles to be included in the new block. One of skill in the art would appreciate then, that in the present systems, less energy is wasted than in the Bitcoin proof-of-work function, for example, because here each user and node that solves a fractional part of the overall puzzle for the given block is rewarded, whereas in Bitcoin proof-of-work, only the node that ultimately finds the solution (target hash) is rewarded and all of the other miners must absorb their losses.

The methods and systems described herein also enable blockchain to be used as a CAPTCHA service, where the CAPTCHAs generated may be used by websites as a content viewing charge. For example, a website viewer may solve one or more of the CAPTCHA puzzles from the trusted source and the website content provider may be rewarded with the newly minted coin from the blockchain. Thus, the present invention also realizes an alternative to advertising or pay walls for monetizing Internet content or services.

As explained above, the proof-of-work system described herein and within the scope of the present disclosure may implement a proof-of-work requirement for generation and creation of blocks on a blockchain, and therefore requires investment of human power for every block. Therefore, the methods and systems described herein may be described in rounds or iterations, wherein the procedures and techniques may be repeated for each new block. In some embodiments of the blockchain architecture described in the present disclosure, the hash of the new block may be used as the seeding for the next set of CAPTCHA puzzles, and in some embodiments, the hash of the new block becomes the seeding for the next block, thereby overlapping and chaining the blocks such that the solved puzzles become the proof-of-work protecting the immutability of the blockchain.

The flowchart and block diagrams in the figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method comprising:
identifying a puzzle set comprising a plurality of computing-resistant puzzles;
receiving a plurality of human-input proposed solutions to at least a subset of the plurality of computing-resistant puzzles of the puzzle set;
for each of the plurality of human-input proposed solutions to the at least a subset of the plurality of computing-resistant puzzles of the puzzle set, confirming the validity of the human-input proposed solutions;
producing a proof-of-work based on at least a threshold quantity of validated ones of human-input proposed solutions to the plurality of computing-resistant puzzles of the puzzle set and the respective computing-resistant puzzles; and
adding a new block to a blockchain database, wherein the new block comprises the proof-of-work.

2. The method of claim 1, wherein the proof-of-work comprises a representation of each of the threshold quantity of validated ones of the human-input proposed solutions to the plurality of computing-resistant puzzles of the puzzle set and a representation of each respective computing-resistant puzzle.

3. The method of claim 1, wherein each of the plurality of computing-resistant puzzles includes a signature of a trusted puzzle generator.

4. The method of claim 1, wherein each of the plurality of computing-resistant puzzles of the puzzle set comprises a series of tests.

5. The method of claim 1, wherein each of the plurality of computing-resistant puzzles of the puzzle set comprises a Completely Automated Public Turing test to tell Computers and Humans Apart (CAPTCHA) puzzle, and each CAPTCHA puzzle comprises a puzzle identifier, a CAPTCHA puzzle image, and a representation of a CAPTCHA puzzle solution.

6. The method of claim 5, wherein the representation of the CAPTCHA puzzle solution comprises a hash value of the CAPTCHA puzzle solution and a prior block of the blockchain.

7. The method of claim 5, wherein confirming the validity of the human-input proposed solutions comprises comparing a hash value of the human-input proposed solution to a hash value of the CAPTCHA puzzle solution.

8. The method of claim 1, wherein the puzzle set comprises a first puzzle set, and further comprising identifying a second puzzle set, wherein the second puzzle set is derived from a hash value of the new block.

9. The method of claim 1, wherein the plurality of human-input proposed solutions to the at least a subset of the plurality of computing-resistant puzzles of the puzzle set comprise a solution indicator encrypted with a private key of a trusted puzzle generator.

10. The method of claim 1, wherein the threshold quantity of validated ones of human-input proposed solutions to the plurality of computing-resistant puzzles of the puzzle set comprises the validated human-input proposed solution to each of the plurality of computing-resistant puzzles of the puzzle set.

11. A non-transitory computer readable storage medium storing instructions that are executable to cause a system to perform operations comprising:
identifying a puzzle set comprising a plurality of computing-resistant puzzles;
receiving a plurality of human-input proposed solutions to at least a subset of the plurality of computing-resistant puzzles of the puzzle set;
for each of the plurality of human-input proposed solutions to the at least a subset of the plurality of computing-resistant puzzles of the puzzle set, confirming the validity of the human-input proposed solutions;
producing a proof-of-work based on at least a threshold quantity of validated ones of human-input proposed solutions to the plurality of computing-resistant puzzles of the puzzle set and the respective computing-resistant puzzles; and
adding a new block to a blockchain database, wherein the new block comprises the proof-of-work.

12. The non-transitory computer readable storage medium of claim 11, wherein the proof-of-work comprises a representation of each of the threshold quantity of validated ones of the human-input proposed solutions to the plurality of computing-resistant puzzles of the puzzle set and a representation of each respective computing-resistant puzzle.

13. The non-transitory computer readable storage medium of claim 11, wherein each computing-resistant puzzle of the plurality of computing-resistant puzzles of the puzzle set comprises a puzzle identifier, a CAPTCHA puzzle image, and a representation of a CAPTCHA puzzle solution.

14. The non-transitory computer readable storage medium of claim 13, wherein the representation of the CAPTCHA puzzle solution comprises a hash value of the CAPTCHA puzzle solution and a prior block of the blockchain.

15. The non-transitory computer readable storage medium of claim 13, wherein confirming the validity of the human-input proposed solutions comprises comparing a hash value of the human-input proposed solution to a hash value of the CAPTCHA puzzle solution.

16. The non-transitory computer readable storage medium of claim 11, wherein the plurality of human-input proposed solutions to the at least a subset of the plurality of computing-resistant puzzles of the puzzle set are encrypted.

17. The non-transitory computer readable storage medium of claim 11, wherein each of the plurality of computing-resistant puzzles is signed by a trusted puzzle generator.

18. The non-transitory computer readable storage medium of claim 11, wherein the puzzle set comprises a first puzzle set, and further comprising monitoring the network to identify a second puzzle set, wherein the second puzzle set is derived from a hash value of the new block.

19. The non-transitory computer readable storage medium of claim 11, wherein each of the plurality of computing-resistant puzzles of the puzzle set comprises a series of sub-puzzles.

20. A computer comprising:
a processor; and
a non-transitory computer readable storage medium storing computer readable instructions that are executed by the processor to case the computer to perform:
monitoring a network to identify a puzzle set comprising a plurality of computing-resistant puzzles;
monitoring the network to identify a plurality of human-input proposed solutions to at least a subset of the plurality of computing-resistant puzzles of the puzzle set;
for each of the plurality of human-input proposed solutions to the at least a subset of the plurality of computing-resistant puzzles of the puzzle set, confirming the validity of the human-input proposed solutions;
producing a proof-of-work based on at least a threshold quantity of validated ones of human-input proposed solutions to the plurality of computing-resistant puzzles of the puzzle set and the respective computing-resistant puzzles; and
adding a new block to a blockchain database, wherein the new block comprises the threshold quantity of validated ones of human-input proposed solutions and the respective computing-resistant puzzles.
